(19) United States
(12) Patent Application Publication
(10) Pub. No.: US 2005/0132840 A1
(43) Pub. Date: Jun. 23, 2005

(54) Automatic balancing device and manufacturing method therefor

(76) Inventors: Atsushi Honda, Suwa-gun (JP); Masaru Uno, Suwa-gun (JP); Takaji Harata, Suwa-gun (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/980,913

(22) Filed: Nov. 3, 2004

(30) Foreign Application Priority Data
Nov. 7, 2003 (JP) JP2003-379117

(51) Int. Cl. F16F 15/22

(52) U.S. Cl. 74/573 R

(57) ABSTRACT

An automatic balancing device including a case body provided with a hollow annular member having an outer peripheral side sliding wall face and concentrically mounted on a rotation shaft, a plurality of balance spherical bodies which are accommodated within the inside of the hollow annular member of the case body and disposed movably in a free manner when the rotation body is rotated, and a lubricant containing a liquid system lubricant which is adhered in a film manner on at least the outer peripheral side sliding wall face of the case body. The lubricant containing a liquid system lubricant may be preferably coated in a concentrated manner on the sliding face, then rotationally driving the rotation body and then suddenly stopping the rotation body to adhere the lubricant in a film manner on the outer peripheral side sliding wall face of the case body.

### CROSS-REFERENCE TO RELATED APPLICATIONS

This application claims priority to Japanese Application No. 2003-379117 filed Nov. 7, 2003, which is incorporated herein by reference.

### FIELD OF THE INVENTION

The present invention relates to an automatic balancing device that is constructed to perform automatic aligning by canceling a rotation unbalance of a rotation body and to a manufacturing method for the automatic balancing device.

### BACKGROUND OF THE INVENTION

An automatic balancing device is constructed such that the rotation unbalance of a rotation body is canceled to perform automatic aligning in order to restrict the rotational vibration of the rotation body. The automatic balancing device is often used in a rotational driving device that is used in general industrial machines, home electrical appliances, or a various kinds of devices such as a computer. Various types of automatic balancing devices have been conventionally proposed. For example, in a device shown in FIGS. 8 and 9, an automatic balancing device “A” including a housing case body 3 in a hollow annular shape is mounted on a rotation shaft 2, which is an output shaft of a motor part 1. A plurality of balance spherical bodies 4 are accommodated in a freely moveable manner within the inside of the housing case body 3 in the hollow annular shape which is installed in the automatic balancing device “A”.

The respective balance spherical bodies 4 begin to move freely by a centrifugal force within the hollow-shaped housing case 3 at a rotation starting time of the motor part 1. When the rotational speed of the motor part 1 exceeds an appropriate operational rotation speed such as the resonance rotation number “CR”, the respective balance spherical bodies 4 move along the inner peripheral sliding wall face of the hollow-shaped housing case 3 in an opposite direction with respect to the center of gravity position of the rotation body including the rotation shaft 2 and the automatic balancing device “A”, in other words, towards a position canceling the rotation unbalance of the rotation body. Thereby, the balancing operation of maintaining the rotational balance of the rotation body is performed. The vibration of the rotation body is decreased and the stabilization of rotating state is attained by the balancing operation (cancel operation) of the balance spherical bodies 4, i.e., the automatic aligning function as described above.

The hollow shaped housing case 3 is formed of various materials. However, from a viewpoint that a complicated, configuration can be formed at a relatively low cost, resin material is often used to form the hollow shaped housing case 3 (see, for example, Japanese Patent Laid-Open No. 2003-235202 and Japanese Patent Laid-Open No. 2001-263426).

The plurality of balance spherical bodies 4 accommodated in the inside of the hollow shaped housing case 3 repeatedly and intensely collide or slide on the sliding face including the outer peripheral side sliding wall face with an operation force depending on the rotational speed. When the hollow shaped housing case 3 is formed of resin material as described above, especially the outer peripheral sliding wall face easily wears due to friction, which causes the sliding resistance to increase for the balance spherical bodies 4 by a short time and thereby a smooth sliding motion may not be attained. As a result; the balance spherical bodies 4 are unable to move to the balancing position sufficiently, which causes the rotational imbalance of the rotation body, or alternatively the collision noise of the balance spherical bodies 4 may be greater to increase the noise.

### SUMMARY OF THE INVENTION

In view of the problems described above, it is an object and advantage of the present invention to provide an automatic balancing device in which balance spherical bodies can silently and smoothly move with a simple construction.

In order to achieve the above object and advantage, according to an embodiment of the present invention, there is provided an automatic balancing device in which a lubricant containing a liquid system lubricant is adhered in a film-like manner on at least the outer peripheral side sliding wall face of the case body within which a plurality of balance spherical bodies are accommodated. According to the automatic balancing device having the construction described above, the lubricant is adhered so as to form uniformly in a film-like manner on the sliding face by satisfactory flowability of the liquid system lubricant constructing the (lubricant. Therefore, smooth motion of the balance spherical bodies are satisfactorily ensured by the sliding lubricating characteristics of the liquid system lubricant.

In the automatic balancing device in accordance with an embodiment of the present invention, it is preferable that a solid system lubricant is added and mixed in the lubricant containing the liquid system lubricant. According to the automatic balancing device having the construction described above, the solid system lubricant remains to maintain the lubricating ability even when the liquid system lubricant is lost by evaporation or scattering. As a result, the lubricating life for the device is lengthened.

In addition, in the automatic balancing device in accordance with an embodiment of the present invention, it is preferable to set the viscosity of the liquid system lubricant in the range between about 10 cts (centistokes) and about 80 cts. According to the automatic balancing device having the construction described above, by appropriately setting the viscosity of the liquid system lubricant, the evaporation and scattering that occurs due to the centrifugal force at the time of rotation when the viscosity of the liquid system lubricant is low can be prevented and, in addition, the increase of the sliding resistance occurring in the case of high viscosity can be prevented.

Further, in accordance with an embodiment of the present invention, at least the outer peripheral side sliding wall face of the case body in the automatic balancing device is formed of resin material whose base material is polycarbonate and the liquid system lubricant is a lubricant of a fluorine system or an α-olefin system. According to the automatic balancing device having the construction described above, the lubricant of the fluorine system or the α-olefin system, which is different, for example, from the lubricant of an ethylene system, does not corrode the case body made of resin material in which polycarbonate is the base material and thus the deterioration of the case body is prevented.

Further, according to an embodiment of the present invention, there is provided a manufacturing method for an automatic balancing device that includes providing a lubricant containing a liquid system lubricant, coating the lubricant in a concentrated manner on the sliding face including the outer peripheral side sliding wall face of the case body, then rotationally driving the rotation body, and then suddenly stopping the rotation body to adhere the lubricant in a film manner on at least the outer peripheral side sliding wall face of the case body. According to the manufacturing method for an automatic balancing device having the construction described above, the lubricant in a film-like shape is easily and uniformly adhered on the sliding face of the case body, and thus the automatic balancing device is extremely efficiently manufactured.

As described above, the automatic balancing device in accordance with the embodiment of the present invention is constructed such that the lubricant containing the liquid system lubricant is adhered in a film-like manner on at least the outer peripheral side sliding wall face of the case body within which a plurality of balance spherical bodies are accommodated. Therefore, the smooth motion of the balance spherical bodies are satisfactorily ensured by sufficient sliding and lubricating characteristics of the liquid system lubricant and thus the automatic balancing device with a high degree of performance can be obtained with a simple construction at a low cost, in which the balance spherical bodies can be silently and smoothly moved.

Further, as described above, in the manufacturing method for an automatic balancing device in accordance with the embodiment of the present invention, the lubricant containing the liquid system lubricant is coated in a concentrated manner on the sliding face including the outer peripheral side sliding wall face of the case body, then rotationally driving the rotation body, and then suddenly stopping the rotation body to adhere the lubricant in a film-like manner on at least the outer peripheral side sliding wall face of the case body. Therefore, the productivity of the automatic balancing device, which is constructed such that the balance spherical bodies are silently and smoothly moved, can be easily improved with a high degree of performance.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a perspective view showing a CD-ROM or a DVD drive unit as an example of a device to which the present invention is applied.

FIG. 2 is a longitudinal cross sectional view showing a motor with an automatic balancing device used in the CD-ROM or DVD drive unit shown in FIG. 1 in accordance with an embodiment of the present invention.

FIG. 3 is a graph showing improved states of initial characteristic according to the relationship between the viscosity and the coating amount when the lubricant in accordance with the present invention is used.

FIGS. 4(a) and 4(b) are graphs showing examples of measurement results of the intermittent life in a device when the lubricant in accordance with the present invention is not used. FIG. 4(a) is a graph when the measuring equipment in a vertical installation type is used and FIG. 4(b) is a graph when a measuring equipment in a lateral installation type is used.

FIGS. 5(a) and 5(b) are graphs showing examples of measurement results of the intermittent life in a device when the lubricant containing liquid system lubricant in accordance with the present invention is used. FIG. 5(a) is a graph when the measuring equipment in a vertical installation type is used and FIG. 5(b) is a graph when the measuring equipment in a lateral installation type is used.

FIGS. 6(a) and 6(b) are graphs showing other examples of measurement results of the intermittent life in a device when the lubricant containing liquid system lubricant to which solid lubricant is added in accordance with the present invention is used. FIG. 6(a) is a graph when the measuring equipment in a vertical installation type is used and FIG. 6(b) is a graph when the measuring equipment in a lateral installation type is used.

FIG. 7 is a graph showing an example of a load that is applied when the intermittent life test is performed.

FIG. 8 is a longitudinal cross sectional view showing a constructional example of a rotational driving device provided with a conventional automatic balancing device.

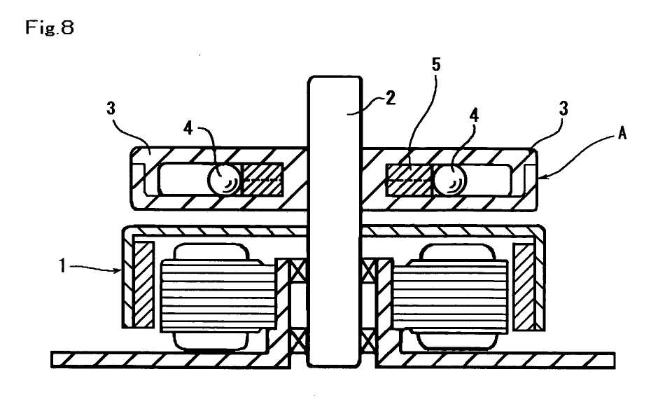

FIG. 9 is an explanatory plan view schematically showing the internal state of the hollow housing case body in the conventional automatic balancing device shown in FIG. 8.

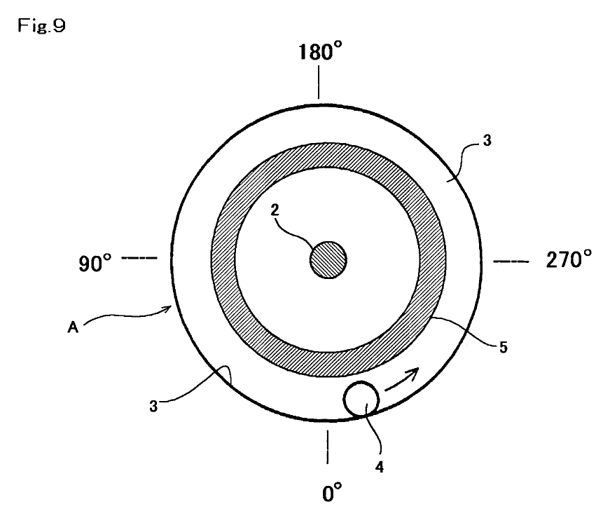

### DETAILED DESCRIPTION OF THE PREFERRED EMBODIMENTS

An embodiment of the present invention will be described in detail below with reference to the accompanying drawings. First, the entire construction of a vertical type of a drive unit for CD-ROM or DVD to which the present invention is applied will be described.

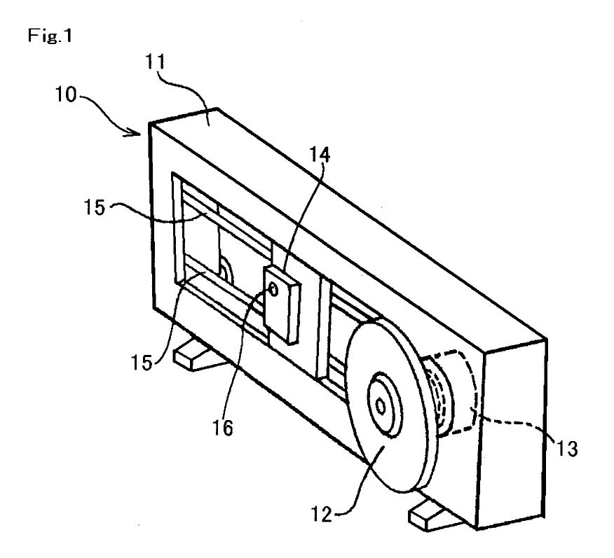

As shown in FIG. 1, on a mechanical chassis 11 of a CD-ROM drive unit 10 which is constructed in a vertical type is mounted a spindle motor part 13 rotationally driving an information recording disk 12 as a member to be rotated and an optical pickup device 14 irradiating a laser beam to the information recording disk 12 to perform writing or reading of information.

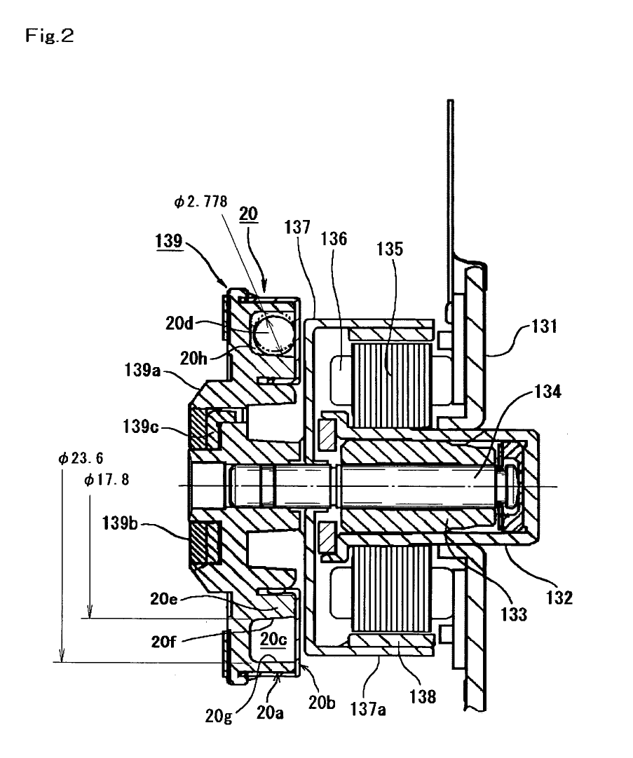

The information recording disk 12 is mounted on a disk table (see the notational symbol 139 in FIG. 2) attached to the rotation shaft of the spindle motor part 13. The optical pickup device 14 is mounted in a reciprocally movable manner on a pair of parallel guide shafts 15, 15 attached to a mechanical chassis 11 and is constructed such that a beam emitted from a laser light source not shown in the drawing is irradiated on the information recording disk 12 through an objective lens 16 and the reflected light from the information recording disk 12 is detected.

In one embodiment of the present invention, the spindle motor part 13 is constructed as shown in FIG. 2, such that a hollow cylinder-shaped bearing holder 132 is mounted on a main body frame 131 formed in an approximately flat plate shape so as to protrude in a substantially horizontal direction and a bearing member 133 is mounted on the inner side of the bearing holder 132 by a press fitting. The bearing member 133 is provided with bearing portions at two positions in an axial direction. However, various types of bearing members such as an oil retaining slide bearing, a ball bearing, a metal bearing or a dynamic pressure bearing device can be adopted as the bearing member 133.

A rotation shaft 134 is rotatably supported at a center portion of the bearing holder 132 through the bearing member 133 and a stator core 135 comprised of a laminated body of silicon steel plates or the like is fitted on the circumferential wall face of the outer periphery side of the bearing holder 132. An insulating layer is formed by coating on the surface of the stator core 135 in a film manner and coil windings 136 are respectively wound around respective salient pole parts of the stator core 135 through the insulator layer.

At a left side position in the drawing where the bearing holder 132 protrudes largely from the main body frame 131 in the axial direction, the center portion of an approximately cup-shaped rotor case 137 which is formed in an approximately hollow cylindrical shape is fixed on the rotation shaft 134 by press fitting or the like. A rotor magnet 138 formed in a ring shape is fixed on the inner peripheral wall face side of an annular circumferential wall part 137a, which is the outer peripheral portion of the rotor case 137. The inner peripheral wall face of the rotor magnet 138 is disposed so as to locate in proximity to close the respective salient pole parts of the above-mentioned stator core 135 from the outside in the radial direction.

A disk table (turntable) 139 formed of resin material, which is nonmagnetic material, in an approximately disk-like shape is fixed on a protruding portion of the rotation shaft 134 on the left side in the drawing. The disk table 139 is fixed by means that its mounting hole formed at a center portion is press-fitted to the rotation shaft 134. An information recording disk (see the notational symbol 12 in FIG. 1), which is put on the disk table 139, is held in a positioned state at the specified position by an approximately conical-shaped positioning projection 139a, which is convexly formed from the fixing portion toward the left side in the drawing. On an apex portion of the positioning projection 139a is mounted a chucking magnet 139b as a holding magnet formed in a ring plate shape through a ring-shaped magnetic yoke plate 139c.

The chucking magnet 139b is provided with two magnetic poles magnetized in the axial direction and disposed so as to be exposed on the left side in the drawing from the center hole of the information recording disk 12 held by the above-mentioned positioning projection 139a. Therefore, a ring-shaped magnetic yoke plate, which is provided on a well-known damper (not shown in the drawing), used as a pressurizing member to the information recording disk 12, is magnetically attracted and held, and thus the information recording disk 12 is held at the prescribed position.

In the disk table 139 is installed an automatic balancing device 20 adjacently in the axial direction for balancing the rotation of the rotation body including the rotor case 137 and the rotation shaft 134.

The automatic balancing device 20 is provided with an automatic aligning function in which the rotation unbalance occurred in the rotation body is cancelled by the balancing operation accompanied with mass movement when the rotational speed of the motor part 13 exceeds the resonance rotation number “CR” of the rotation body. The disk table 139 and a main hollow annular member 20a in an approximately cup shape formed integrally with the disk table 139 are formed of resin material whose base material is polycarbonate. A sub hollow annular member 20b formed of a press product or the like of nonmagnetic material is fitted to the main hollow annular member 20a from the right side in the drawing in the axial direction such that their respective aperture parts face each other and thereby a hollow housing case body 20c is constructed.

The hollow housing case body 20c formed as described above is integrally rotated with the disk table 139. An annular space for accommodating a plurality of balance spherical bodies 20d is formed on the internal side of the hollow housing case body 20c. The balance spherical bodies 20d comprising of an appropriate mass body are accommodated in the annular space in a freely movable manner in all directions including the circumferential and radial direction. These balance spherical bodies 20d are assembled so as to be freely movable in all directions including the radial direction and the circumferential direction along the sliding face including the bottom wall face of the sub hollow annular member 20b and the outer peripheral side sliding wall face 20g of the main hollow annular member 20a. As a result, the balancing operation of the rotation body including the rotor case 137, the rotation shaft 134 and the like is performed.

In other words, when the rotational speed of the spindle motor part 13 reaches a predetermined appropriate operation rotational speed, mass adjustment is performed by means that the balance spherical bodies 20d move in the opposite direction with respect to the center of gravity position of the rotation body. Namely, the balance spherical bodies 20d move toward an outer position in the radial direction as shown in the two-dot chain line in FIG. 2 to cancel the rotation unbalance of the rotation body. Thereby, the rotation of the rotation body is balanced and the automatic aligning of the rotation body is performed by reducing the vibration of the rotation body and thus stabilization of rotation is attained.

A rotation auxiliary member 20e is disposed in the inside of the hollow housing case body 20c for regulating or assisting the free movement of the respective balance spherical bodies 20d. This rotation auxiliary member 20e is integrally formed with the disk table 139 in the center side area of the disk table 139 and, for example, is formed in a substantially regular polyhedral shape so as to be concentric with the disk table 139.

More concretely, a plurality of planar spherical body operating faces 20f are formed on the outer periphery side of the rotation auxiliary member 20e. Each of the planar spherical body operating faces 20f is disposed such that each of the above-mentioned balance spherical body 20d may be able to slid or roll by abutting thereon. Therefore, in the range of slow speed rotation including at the rotation starting time, each of the planar spherical body operating faces 20f of the rotation auxiliary member 20e slides on each of the balance spherical bodies 20d, and thus a moderated operation force is applied to the balance spherical body 20d toward an upstream side in the rotational direction. Thereby, each of the balance spherical bodies 20d is moved toward the outside smoothly.

In the embodiment of the present invention, the dimension of the outer diameter of the spherical body operating face 20f formed on the outer peripheral side of the rotation auxiliary member 20e is set to be a diameter of about 17.8 mm and the dimension of the inner diameter of the outer peripheral side sliding wall face 20g of the main hollow annular member 20a is set to be a diameter of about 23.6 mm. The width dimension of the outer peripheral side sliding wall face 20g in the axial direction is set to be about 2.8 mm. Moreover, in the embodiment of the present invention, the dimension of the outer diameter of the respective balance spherical bodies 20d is set to be a diameter of about 2.778 mm. Thirteen balance spherical bodies 20d having the dimension described above are accommodated in the inside of the hollow housing case body 20c.

A lubricant containing a liquid system lubricant is adhered in a thin film shape on the sliding face of the hollow housing case body 20c, in other words, the bottom wall face of the sub hollow annular member 20b and the outer peripheral side sliding wall face 20g of the main hollow annular member 20a. The liquid system lubricant constructing the thin film-shaped lubricant is uniformly diffused on the sliding face based on its satisfactory flowability. Especially, in the present embodiment, the liquid system lubricant is further more uniformly adhered in the thin film shape by means of a method described below.

Oil such as a fluorine system or an α-olefin system is used as the liquid system lubricant with amount of about 0.1 mg-5.0 mg. The viscosity of the liquid system lubricant is, for example, set in the range of about 10 cst (centistokes) to about 80 cst. The reason for the range is that it is necessary to prevent evaporation and scattering due to the centrifugal force at the time the rotation occurred in the case of low viscosity and to prevent the increase of sliding resistance occurring in the case of high viscosity.

In the embodiment of the present invention as described above, the lubricant containing liquid system lubricant adheres to the sliding face of the hollow housing case body 20c so as to have an uniform film thickness by satisfactory flowability of the liquid lubricant. The satisfactory sliding lubricating ability of the liquid system lubricant sufficiently ensures smooth motion of the balance spherical bodies 20d.

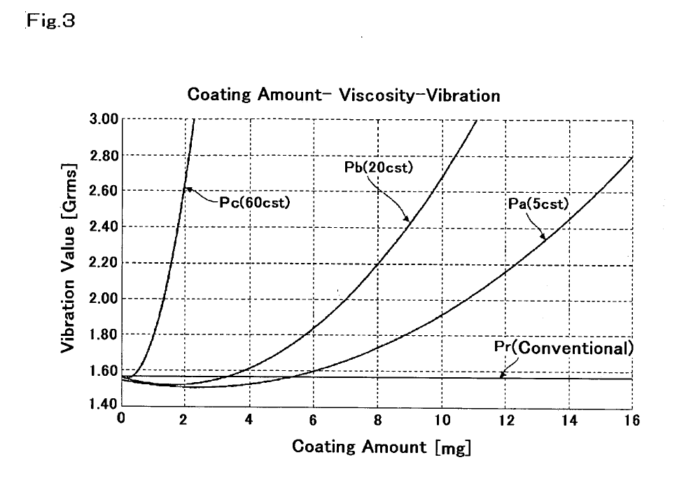

Actual initial characteristics of the automatic balancing device in which the liquid system lubricant is coated on the sliding face are measured and shown in FIG. 3 as an example. The initial characteristic (vertical axis) of vibration value in the conventional standard device Pr in which the lubricant is not used is shown by the horizontal solid line. On the other hand, it is confirmed that the initial characteristics (vertical axis) of vibration value in the device in which the lubricant in accordance with the embodiment of the present invention is coated are improved by means of selecting the viscosity (parameter) of the lubricant and the coated amount (horizontal axis) in an appropriate range. In other words, it is apparent from the measurement results Pa (viscosity of 5 cst), Pb (viscosity of 20 cst), and Pc (viscosity of 60 cst) of vibration characteristics shown in FIG. 3, that the initial characteristic (vertical axis) of vibration value is clearly reduced in comparison with the conventional device, for example, when the viscosity of lubricant in accordance with the present invention is set to be in an appropriate range from about 5 cst to about 20 cst and the coated amount of the lubricant is set to be in an appropriate range, for example, to about 5.5 mg or to about 3.5 mg.

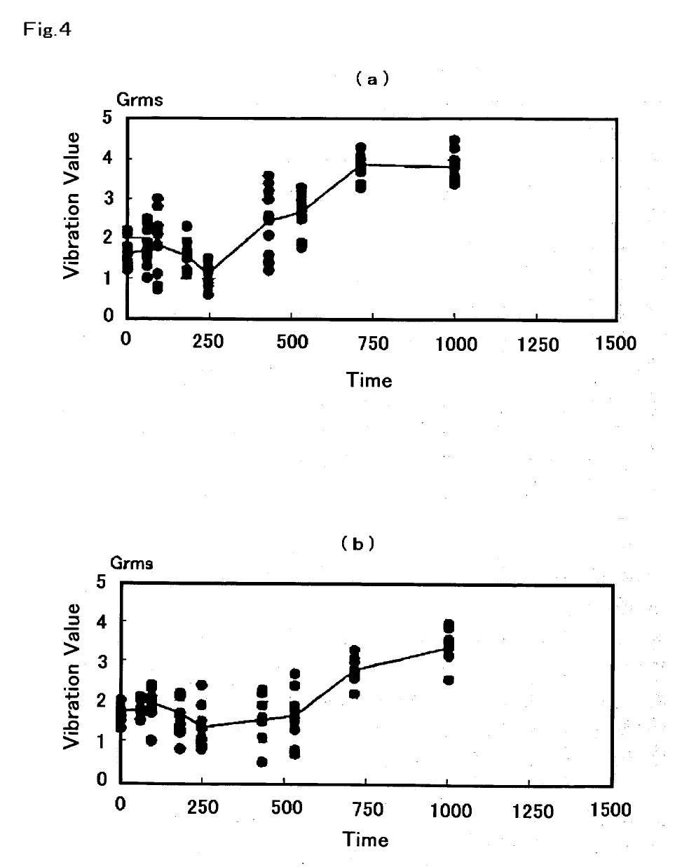

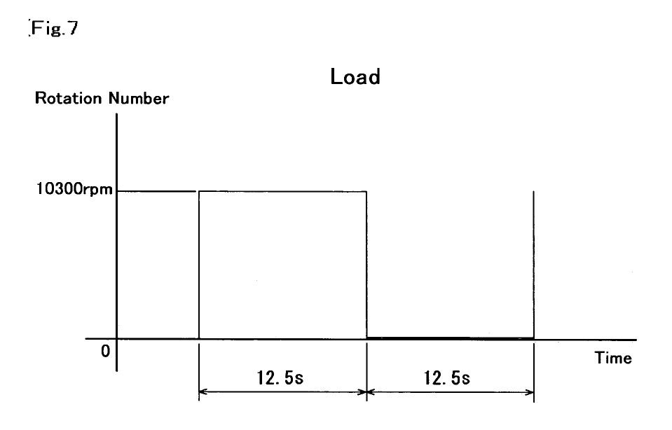

Next, the results will be described with reference to FIGS. 4(a) and 4(b) through 7, which are obtained by performing an intermittent life test by using a testing equipment corresponding to a device in a vertical installation type like the above-mentioned embodiment while a prescribed load is applied. In the intermittent life test, the load is applied which, for example, rotationally drives at the speed of 10,300 (rpm) at every other 12.5 second as shown in FIG. 7. After the load is applied, the motor is detached from the testing equipment and attached to the measuring equipment to measure the vibration value. After the vibration measurement is performed, the motor is detached from the measuring equipment and reattached to the testing equipment to continue the intermittent life test described above. As the measuring equipment, both the measuring equipments of a vertical installation type and a lateral installation type are used. The vibration value in vertical attitude is measured by the vertical installation type measuring equipment and the vibration value in lateral attitude is measured by the lateral installation type measuring equipment.

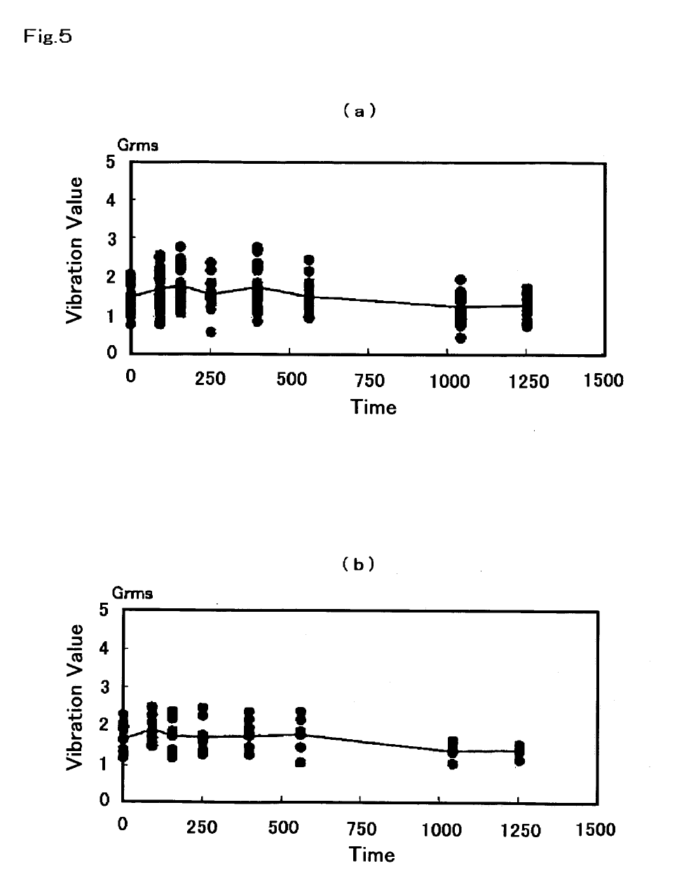

As a result, in the conventional device in which the lubricant is not used, both the vibration values (vertical axis) in vertical attitude measured by the vertical installation type measuring equipment shown in FIG. 4(a) and the vibration values (vertical axis) in lateral attitude measured by the lateral installation type measuring equipment shown in FIG. 4(b) increase rapidly from the elapse of certain time (horizontal axis). On the other hand, in the device in which the lubricant in accordance with the present embodiment is used, both the vibration values (vertical axis) in vertical attitude measured by the vertical installation type measuring equipment shown in FIG. 5(a) and the vibration values (vertical axis) in lateral attitude measured by the lateral installation type measuring equipment shown in FIG. 5(b) are maintained small almost independently of the lapse of time (horizontal axis). The measurement results of the intermittent life test shown in FIGS. 5(a) and 5(b) are the case when the liquid system lubricant with the viscosity of 64 cst is used.

In addition, it is confirmed that, during the rotation of the automatic balancing device in accordance with the embodiment of the present invention, the collision noise during rotation is reduced and the noise level in the device is remarkably decreased because the liquid system lubricant in accordance with the above-mentioned present embodiment is interposed between the respective balance spherical bodies 20d and the sliding face.

Further, since the oil film of the liquid system lubricant is formed on the surface of the respective balance spherical bodies 20d, rusting on the balance spherical body 20d is prevented and thus satisfactory characteristics are maintained for a long period of time. Especially, in the present embodiment, when the lubricant of a fluorine system or an α-olefin system is used as the liquid system lubricant. The lubricant of the fluorine system or the α-olefin system, which is different, for example, from the lubricant of an ethylene system, does not corrode the case body 20c made of resin material in which polycarbonate is the base material and thus the deterioration of the case body 20c is prevented. Accordingly, satisfactory characteristics are maintained for a long period of time.

Alternatively, the lubricant containing the above-mentioned liquid system lubricant may further contain a solid system lubricant. When the solid system lubricant is mixed in the lubricant containing the liquid system lubricant, the solid system lubricant continues to remain even when the liquid system lubricant is lost by evaporation or scattering. Therefore, the lubricating ability can be maintained and the lubricating service life of the device is not shortened.

When a low-friction solid system lubricant such as PTFE, MCA, and graphite is employed, satisfactory slidability can be obtained. However, when an excessive quantity of the solid based lubricant is added, adhesion or deposition occurs on the sliding face including the outer peripheral side sliding wall face 20g of the hollow housing case body 20c and the sliding resistance may increase. Therefore, an appropriate amount of solid system lubricant is used, for example, in the range of about 0.01 mg to about 0.5 mg to ensure satisfactory slidability.

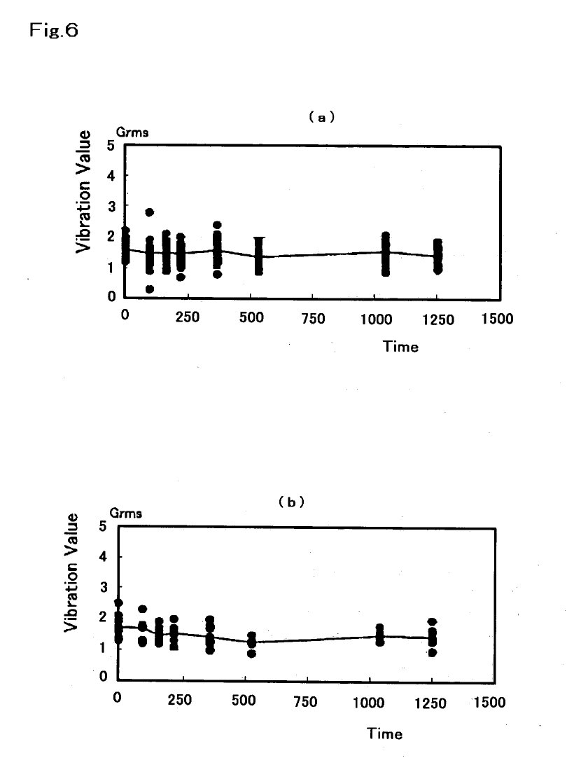

For example, the measurement results of the intermittent life test shown in FIGS. 6(a) and 6(b) show the case that the lubricant of 4 mg with a viscosity of 64 cst respectively containing a solid lubricant of 10 wt. % and a liquid lubricant of 10 wt. % is used. As shown in FIGS. 6(a) and 6(b), both the vibration values (vertical axis) in vertical attitude measured by the vertical installation type measuring equipment shown in FIG. 6(a) and the vibration values (vertical axis) in lateral attitude measured in the lateral installation type measuring equipment shown in FIG. 6(b) are maintained small almost independently of the lapse of time (horizontal axis).

When the lubricant containing the liquid system lubricant or the lubricant containing the mixture of the liquid system lubricant and the solid system lubricant is to be attached on the sliding face of the hollow housing case body 20c, the lubricant is coated in a concentrated manner on the sliding face of the hollow housing case body 20c. The concentrated coating of the lubricant is performed at one or two spots, for example, appropriately selected and specified on the sliding face.

Subsequently, the rotation body including the hollow housing case body 20c is rotationally driven to an appropriate rotational speed, and then the rotation body is suddenly stopped. Thereby, the lubricant containing the liquid system lubricant or the lubricant containing the mixture of the liquid system lubricant and the solid system lubricant satisfactorily fluidizes along the sliding face of the hollow housing case body 20c. Accordingly, the film of the lubricant is extremely easily and uniformly formed and the automatic balancing device with a high degree of performance is extremely efficiently manufactured.

The present invention has been described in detail using the embodiments, but the present invention is not limited to the embodiments described above and many modifications can be made without departing from the present invention.

For example, in the above-mentioned embodiment, the present invention is applied to the device that is vertically disposed. However, the present invention can be similarly applied to a device of a lateral installation type or a horizontal installation type.

In addition, in the above-mentioned embodiment, an information recording disk is used as a member to be rotated. However, the present invention can be similarly applied to a device using various types of another member to be rotated.

The present invention described above can be widely adopted as an automatic balancing device that is used for various rotational driving devices including various types of motors for disk drive.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An automatic balancing device comprising:
a case body which includes a hollow annular member having an outer peripheral side sliding wall face and is concentrically mounted on a rotation shaft of a rotation body constructing a motor part;
a plurality of balance spherical bodies which are accommodated within an inside of the hollow annular member of the case body and at least disposed movably in a radial direction and a circumferential direction when the rotation body is rotated; and
a lubricant containing a liquid system lubricant which is adhered in a film manner on at least the outer peripheral side sliding wall face of the case body,
wherein, when a rotation frequency of the rotation body becomes larger than a predetermined frequency, the balance spherical bodies move while contacting on the sliding face including the outer peripheral side sliding wall face of the case body to generally align a center of gravity of an entire rotation body with a rotation center of the rotation body and a rotation unbalance of the rotation body is canceled so as to perform an automatic aligning.

2. The automatic balancing device according to claim 1, wherein a solid system lubricant is added and mixed in the lubricant containing the liquid system lubricant.

3. The automatic balancing device according to claim 1, wherein a viscosity of the liquid system lubricant is set in a range between about 10 cts and about 80 cts.

4. The automatic balancing device according to claim 1, wherein at least the outer peripheral side sliding wall face of the case body is formed of a resin material whose base material is polycarbonate and the liquid system lubricant is a lubricant of a fluorine system or an α-olefin system.

5. A manufacturing method for an automatic balancing device comprising:
providing an automatic balancing device including a case body which includes a hollow annular member having an outer peripheral side sliding wall face and is concentrically mounted on a rotation shaft of a rotation body constructing a motor part and a plurality of balance spherical bodies which are accommodated within an inside of the hollow annular member of the case body and at least disposed movably in a radial direction and a circumferential direction when the rotation body is rotated, wherein, when a rotation frequency of the rotation body becomes larger than a predetermined frequency, the balance spherical bodies move while contacting on the sliding face including the outer peripheral side sliding wall face of the case body to generally align a center of gravity of an entire rotation body with a rotation center of the rotation body and a rotation unbalance of the rotation body is canceled so as to perform an automatic aligning;
providing a lubricant containing a liquid system lubricant;
coating the lubricant in a concentrated manner on the sliding face including the outer peripheral side sliding wall face of the case body;
then rotationally driving the rotation body; and
then suddenly stopping the rotation body to adhere the lubricant in a film manner on at least the outer peripheral side sliding wall face of the case body.

6. The manufacturing method for an automatic balancing device according to claim 5, wherein a solid system lubricant is added and mixed in the lubricant containing the liquid system lubricant.

7. The manufacturing method for an automatic balancing device according to claim 5, wherein a viscosity of the liquid system lubricant is set in a range between about 10 cts and about 80 cts.

8. The manufacturing method for an automatic balancing device according to claim 5, wherein at least the outer peripheral side sliding wall face of the case body is formed of resin material whose base material is polycarbonate and the liquid system lubricant is a lubricant of a fluorine system or an α-olefin system.

9. An automatic balancing device comprising:
a case body that includes a hollow annular member having an outer peripheral side sliding wall face and is concentrically mounted on a rotation shaft of a rotation body constructing a motor part;
a plurality of balance spherical bodies that are accommodated within the hollow annular member of the case body and at least disposed movably in a radial direction and a circumferential direction when the rotation body is rotated; and
a lubricant containing a liquid system lubricant that is coated as a film on at least the outer peripheral side sliding wall face of the case body,
wherein, when a rotation frequency of the rotation body becomes larger than a predetermined frequency, the balance spherical bodies move while contacting on the sliding face including the outer peripheral side sliding wall face of the case body to generally align a center of gravity of an entire rotation body with a rotation center of the rotation body and a rotation unbalance of the rotation body is canceled to perform an automatic aligning.

10. The automatic balancing device according to claim 9, wherein a solid system lubricant is added and mixed in the lubricant containing the liquid system lubricant.

11. The automatic balancing device according to claim 9, wherein a viscosity of the liquid system lubricant is set in a range between about 10 cts and about 80 cts.

12. The automatic balancing device according to claim 9, wherein at least the outer peripheral side sliding wall face of the case body is formed of a resin material whose base material is polycarbonate and the liquid system lubricant is a lubricant of a fluorine system or an α-olefin system.

13. A manufacturing method for an automatic balancing device comprising:
providing an automatice balancing device inclduing a case body that includes a hollow annular member having an outer peripheral side sliding wall face and is concentrically mounted on a rotation shaft of a rotation body constructing a motor part and a plurality of balance spherical bodies that are accommodated within the hollow annular member of the case body and at least disposed movably in a radial direction and a circumferential direction when the rotation body is rotated, wherein, when a rotation frequency of the rotation body becomes larger than a predetermined frequency, the balance spherical bodies move while contacting on the sliding face including the outer peripheral side sliding wall face of the case body to generally align a center of gravity of an entire rotation body with a rotation center of the rotation body and a rotation unbalance of the rotation body is canceled to perform an automatic aligning.
providing a lubricant containing a liquid system lubricant;
coating the lubricant in a concentrated manner on the sliding face including the outer peripheral side sliding wall face of the case body;
then rotationally driving the rotation body; and
then suddenly stopping the rotation body to adhere the lubricant in a film manner on at least the outer peripheral side sliding wall face of the case body.

14. The manufacturing method for an automatic balancing device according to claim 13, wherein a solid system lubricant is added and mixed in the lubricant containing the liquid system lubricant.

15. The manufacturing method for an automatic balancing device according to claim 13, wherein a viscosity of the liquid system lubricant is set in a range between about 10 cts and about 80 cts.

16. The manufacturing method for an automatic balancing device according to claim 13, wherein at least the outer peripheral side sliding wall face of the case body is formed of resin material whose base material is polycarbonate and the liquid system lubricant is a lubricant of a fluorine system or an α-olefin system.
